(19) United States
(12) Patent Application Publication
(10) Pub. No.: US 2026/0340958 A1
(43) Pub. Date: Oct. 29, 2026

(54) ARTIFICIAL INTELLIGENCE ASSISTED AUGMENTED REALITY SYSTEM AND NON-TRANSITORY COMPUTER READABLE MEDIUM

(71) Applicant: ADAT Technology Co., Ltd., Taipei City (TW)

(72) Inventors: Kai-Hung SU, Tainan City (TW); Yu-Ching CHANG, Tainan City (TW); Yen-Ting LAI, Tainan City (TW)

(21) Appl. No.: 19/278,805

(22) Filed: Jul. 24, 2025

(30) Foreign Application Priority Data
Apr. 29, 2025 (TW) 114116164

(51) Int. Cl. G06T 19/00

(52) U.S. Cl. CPC G06T 19/006

(57) ABSTRACT

An artificial intelligence (AI) assisted augmented reality (AR) system includes an editing platform, a computer system, and an AR device. The editing platform is configured to edit expert knowledge data to be a knowledge base. The computer system is configured to generate an AI agent module according to the knowledge base and generate a solution and an application program from analyzing the query data by the AI agent module. The AR device is configured to obtain the application program from the computer system and execute the application program.

### RELATED APPLICATIONS

This application claims priority to Taiwan Application Serial Number 114116164, filed Apr. 29, 2025, which is herein incorporated by reference.

### BACKGROUND

### Technical Field

The present disclosure relates to artificial intelligence (AI) and augmented reality (AR), and more particularly to an AI assisted AR system and a non-transitory computer readable medium.

### Description of Related Art

General operations in a work field rely on the professional capabilities of employees to cope with the complex work. Skill developments of the employees include, for example, basic training, professional training, and on-job training (OJT). In general, people who have passed the above training and been worked for a period of time should be able to reduce human errors to a certain percentage, but practically the human errors caused by invalid training still occur frequently. However, under the influence of declining birth rate in the world, professional knowledge is often not successfully passed on after retirement. New recruits are often overloaded with psychological factors due to poor training, resulting in human errors that may occur in the realistic field due to factors such as human nature and lack of professionalism in the enterprise, resulting in inability to ensure the quality of work and the correct implementation of verification results.

### SUMMARY

One aspect of the present disclosure is to provide an artificial intelligence (AI) assisted augmented reality (AR) system which includes an editing platform, a computer system, and an AR device. The editing platform is configured to edit expert knowledge data to be a knowledge base. The computer system is coupled to the editing platform, and is configured to generate an AI agent module according to the knowledge base and generate a solution and an application program from analyzing query data by the AI agent module. The AR device is coupled to the computer system, and is configured to obtain the application program from the computer system and execute the application program.

In some embodiments, the AI assisted AR system further includes an Internet of Things (IoT) device that is coupled to the computer system and is configured to provide IoT data to the computer system, such that the AI agent module determines a problem corresponding to the query data according to the IoT data.

In some embodiments, the IoT device is an Artificial Intelligence of Things (AIoT) executer.

In some embodiments, the editing platform is further configured to edit the IoT data and the expert knowledge data to be the knowledge base.

In some embodiments, the editing platform comprises a design builder, a gauge builder, a knowledge extractor, a knowledge editor, a Q&A experience editor, and a knowledge transformer.

In some embodiments, the editing platform comprises a knowledge extractor, a knowledge editor, and a knowledge transformer.

In some embodiments, the editing platform is a no-code editing platform.

In some embodiments, the AI agent module comprises a multi-model problem identification, definition, and solution system, a knowledge application ecosystem, and a human-machine collaboration scheduling system.

In some embodiments, the query data are provided by an electronic device, and wherein the computer system is further configured to transmit the solution to the electronic device.

In some embodiments, the electronic device providing the query data is a computer or smart glasses.

In some embodiments, the computer system is further configured to upload a result of executing the application program by the AR device to a management platform.

In some embodiments, the AR device is smart glasses, a robot, or a drone.

In some embodiments, the AR device is configured to generate a virtual screen based on execution of the application program.

In some embodiments, the AR device includes transparent lenses for displaying a real scene as well as the virtual screen.

In some embodiments, the AR device includes an image sensor, a processor, and a screen. The image sensor is configured to capture a real scene. The processor is configured to superimpose the real scene and the virtual screen. The screen is configured to display a superimposed image of the real scene and the virtual screen.

Another aspect of the present disclosure is to provide a non-transitory computer readable medium storing computer program instructions that, when executed by a processor, cause the processor to: edit expert knowledge data to be a knowledge base; generate an AI agent module according to the knowledge base; execute the AI agent module; generate a solution and an application program from analyzing query data by the AI agent module; and provide the application program to an AR for execution.

In some embodiments, the computer program instructions further cause the processor to detect an execution result of the application program and uploads a report.

In some embodiments, the computer program instructions further cause the processor to edit extracted data into the knowledge base according to a particular knowledge.

In some embodiments, the computer program instructions further cause the processor to transform data in the knowledge base into machine readable data.

In some embodiments, the computer program instructions further cause the processor to receive IoT data for the AI agent module to determine a problem corresponding to the query data according to the IoT data.

### BRIEF DESCRIPTION OF THE DRAWINGS

The foregoing aspects and many of the accompanying advantages of the present disclosure will become more readily appreciated as the same becomes better understood by reference to the following detailed description, when taken in conjunction with the accompanying drawings.

FIG. 1 is a schematic structural diagram of an AI assisted AR system in accordance with some embodiments of the present disclosure.

FIG. 2 is a schematic flowchart of an AI assisted AR method in accordance with some embodiments of the present disclosure.

### DETAILED DESCRIPTION

The detailed explanation of the present disclosure is described as following. The described preferred embodiments are presented for purposes of illustrations and description, and they are not intended to limit the scope of the present disclosure.

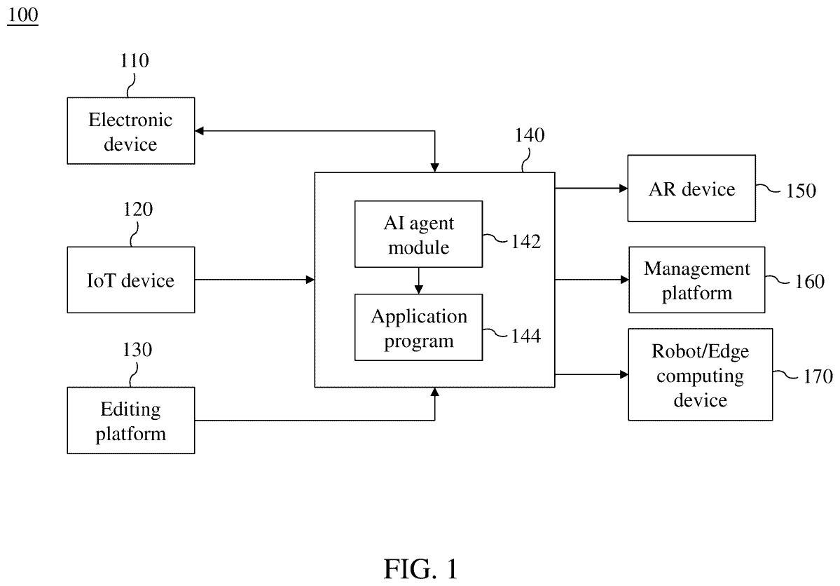

FIG. 1 is a schematic structural diagram of an AI assisted AR system 100 in accordance with some embodiments of the present disclosure. As shown in FIG. 1, the AI assisted AR system 100 includes an electronic device 110, an IoT device 120, an editing platform 130, a computer system 140, an AR device 150, a management platform 160, and a robot/edge computing device 170.

The electronic device 110 is configured to provide query data to the computer system 140. The query data may be generated in a data format of, such as text, error code, voice, image, and video. The electronic device 110 may be a computer (e.g., a personal computer, a laptop computer, or a tablet computer), smart glasses, or another suitable device. A user may generate the query data in a text or audio format by means of 5W1H, i.e., using question words such as who, when, what, where, why and/or how, or providing query data in a multimedia format such as image and/or video, but the present disclosure is not limited thereto.

The IoT device 120 is configured to provide IoT data to the computer system 140. The IoT data may be, for example, but not limited to, detected data and machine parameter data sensed by the IoT device 120 at a particular field. In certain embodiments, the IoT device 120 is an Artificial Intelligence of Things (AIoT) executer that has functions of real-time process and data analysis. In addition, in various embodiments, the AI assisted AR system 100 may include plural IoT devices 120.

The editing platform 130 is configured to edit expert knowledge data to be a knowledge base. In some embodiments, the editing platform 130 is a no-code editing platform, such that the user can edit the knowledge base through a graphic user interface and configuration. In specific, the user can edit an expert knowledge base, an application program and an AI object detection model thereof, object anchoring information, an operating flow, a remote monitoring device information input, and/or anomaly detection details through a no-code development environment, and output the application program to, for example, an AR device, a robot, a drone, or an IoT or AIoT device for application in various vertical fields. In addition, the editing platform 130 may be a corporation AI expert system with AR (CAESAR) edit platform (CEP) combined with expert-level AI system functions, such that the user does not need to have the ability to develop programs but only focuses on knowledge building in his professional field, and can edit the professional knowledge data into a dedicated knowledge base through the editing platform 130.

In some embodiments, the editing platform 130 includes a knowledge extractor, a knowledge editor, and a knowledge transformer, in which the knowledge extractor is configured to extract data, the knowledge editor is configured to edit the extracted data into the knowledge base according to a particular knowledge, and the knowledge transformer is configured to transform the data in the knowledge base into machine readable data. In certain embodiments, in addition to the knowledge extractor, the knowledge editor, and the knowledge transformer, the editing platform 130 further includes a design builder, a gauge builder, and a Q&A experience editor. The editing platform 130 may include one or more servers and databases, in which the database(s) store the knowledge base, and various elements of the editing platform 130 (the knowledge extractor, the knowledge editor, and the knowledge transformer) may include one or more programs, libraries, or cloud services that is/are executed by the server(s).

The computer system 140 is coupled to the electronic device 110, the IoT device 120, and the editing platform 130. The computer system 140 is configured to generate an AI agent module 142 according to the knowledge base provided by the editing platform 130 and execute the AI agent module 142, so as to analyze the query data by the AI agent module 142 to determine the corresponding problem and generate the corresponding solution (e.g., a standard operating procedure) and an application program 144. In some embodiments, the computer system 140 provides a multi-model input interface (including text, voice, and/or IoT detected data) for accurately identifying the problem in the particular field and provide the corresponding solution, and has functions of knowledge update and optimization to ensure the continuous evolution of the knowledge base. The generated solution may be transmitted back to the electronic device 110 from the computer system 140.

The computer system 140 may further receive the IoT data provided by the IoT device 120, such that the AI agent module 142 defines the problem corresponding to the query data according to the IoT data. The generated AI agent module 142 may include a multi-model problem identification, definition, and solution system, a knowledge application ecosystem, and/or a human-machine collaboration scheduling system, in which the multi-model problem identification, definition, and solution system provides problem classification, problem definition, and solution generation, the knowledge application ecosystem provides functions of knowledge base application, knowledge base management, and knowledge base update, and the human-machine collaboration scheduling system provides functions of task coordination, resource allocation, and real-time monitoring. The computer system 140 may include one or more servers and databases, in which the database(s) store the AI agent module 142 and the application program 144, and the AI agent module 142 may include one or more programs, libraries, or cloud services that is/are executed by the server(s).

The AR device 150 is coupled to the computer system 140. The AR device 150 is configured to obtain the application program 144 from the computer system 140 and execute the application program 144, so as to generate a virtual screen including objects such as characters and/or icons. People holding the AR device 150 may solve the problem in the particular field according to the indication of the virtual screen. The AR device 150 may verify the execution result of the application program 144 through AI detection. The AR device 150 may be implemented by, for example, smart glasses, a smartwatch, a tablet, or a monitor system, and may include at least a monitor, a processor, an inertial sensing unit, a depth sensor, or a combination thereof, but the present disclosure is not limited thereto.

For example, in a case in which the AR device 150 is smart glasses, such smart glasses include transparent lenses that allow for the user to see the real scene as well as the virtual screen displayed thereon. As such, the visual effect of virtual and real superimposition can be achieved. In a case in which the AR device 150 is a smartphone or a tablet, the AR device 150 further includes an image sensor for capturing a real scene, a processor (e.g., an image processor) for superimposing the real scene and the virtual screen, and a screen for displaying the superimposed image.

The AR device 150 may also calculate its position in the real environment through the inertial sensing unit, and such position may be further corrected by image recognition, such as capturing a point cloud in the real environment and comparing it with a point cloud stored in a database to correct the position. The AR device 150 may provide functions of navigation, voice prompt, text prompt, image prompt, abnormal condition identification and object detection when executing the application program 144.

The AR device 150 may further be implemented as a robot or a drone, and the computer system 140 may decide to deploy people, a robot, and/or a drone to the particular field to perform a task for solving the problem, so as to achieve the optimized hybrid operating mode. In particular, in a dangerous field or a field that is hard to reach, the computer system 140 may decide to deploy a robot or a drone to perform a tack to solve the problem and verify the result for ensuring operational safety.

The management platform 160 is coupled to the computer system 140 and may receive the result of executing the application program 144 by the AR device 150, such that the AR device 150 may automatically store and record data when performing an inspection in the particular field, and the management platform 160 may perform quality confirmation and generate a digital inspection report with a high credibility accordingly. The administrator may promptly handle the real-time operation status in the particular field and performs performance analysis and trend forecasting by the management platform 160. The generated digital inspection report further provides key performance indicator of various execution units. For abnormal condition handling, the management platform 160 can quickly evaluate and suggest whether to deploy a robot or a drone to the particular field for manipulation, so as to assist the administrator to make the most appropriate decision. The management platform 160 may further continuously optimize the human-machine collaboration model based on historical data, thereby improving the overall operational efficiency.

The robot/edge computing device 170 is coupled to the computer system 140. The robot/edge computing device 170 is configured to obtain the application program 144 from the computer system 140 and execute the application program 144 to perform a computation and solve the problem in at the particular field according to the computational result. The robot/edge computing device 170 may include one or more servers with a computational function and may perform a corresponding action according to the computational result.

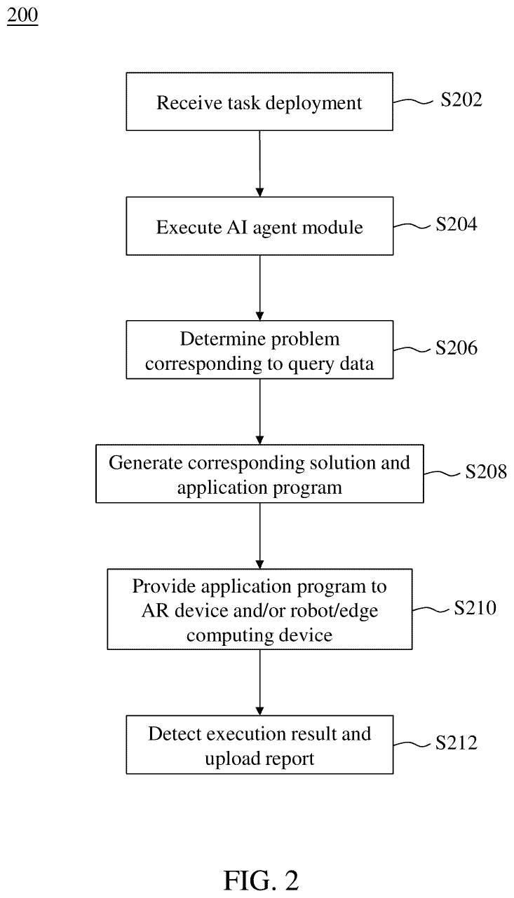

FIG. 2 is a schematic flowchart of an AI assisted AR method 200 in accordance with some embodiments of the present disclosure. The AI assisted AR method 200 may be performed by the AI assisted AR system 100 in FIG. 1 or another system having a similar structure. At Step S202, the system receives a task deployment, e.g., inspection of a particular field. At Step S204, the system generates an AI agent module according to the knowledge base and executes the AI agent module. In some embodiments, the system has functions of knowledge extraction, knowledge editing, and knowledge transformation, and may edit the extracted data into the knowledge base and transform the data in the knowledge base into machine readable data. At Step S206, the system determines the problem corresponding to the query data. The system may receive IoT data for the AI agent module to determine the problem corresponding to the query data according to the IoT data. At Step S208, the system generates a corresponding solution and an application program according to the determined problem. The system may classify and define the problem and generate a corresponding solution, and may apply, manage and update the knowledge base, and has functions of task coordination, resource allocation and real-time monitoring. At Step S210, the system provides the application program to an AR device, such that the AR device may generate a virtual screen including objects such as characters and/or icons, and/or provide the application program to a robot/edge computing device, such that the robot/edge computing device executes the application program to compute and solve the problem in the particular field according to the computational result. At Step S212, the system detects the execution result of the application program and uploads a report.

The AI assisted AR method 200 may be programmed to become computer program instructions that can be executed by a processor and stored in a non-transitory computer readable medium accessible to the processor. The non-transitory computer readable medium may be a read-only memory (ROM), a flash memory, a floppy disk, a hard disk, an optical disc, a Universal Serial Bus (USB) flash, a magnetic tape, an Internet-accessible database, or another computer readable medium that is obvious to those ordinary skilled in the art.

According to the AI assisted AR system and method of the present disclosure, a user can use a devices such as a computer and smart glasses to query the facing problem in a pre-defined operating field and interact with the system by text or voice, and can also automatically identify the problem through the sensing function of the smart glasses, supplemented by collecting information from various IoT devices to ensure the accuracy of problem definition. In addition, the AI assisted AR system of the present disclosure can create a unified standardized communication protocol to ensure that the AI process can run smoothly in various terminal devices. Through the artificial intelligence guidance and real-time artificial intelligence detection technology, problem solutions and standardized operation process designs can be promptly provided, so as to achieve one-stop development solutions from knowledge imports to practical applications.

In the AI assisted AR system and method of the present disclosure, the editing platform can have a no-code editing function for generating expert knowledge contents and solutions required for the AI agent module. A user can utilize the no-code editing environment to set up an expert domain knowledge base as well as a system standard operating procedure and a Q&A experience knowledge base corresponding to the expert domain. The no-code editing environment and the standardized communication protocol provided by the editing platform can also ensure that expert system and the AI process can run smoothly in various terminal devices. In addition, the editing platform can also integrate editing tools (e.g., a no-code design builder and a no-code meter builder) to develop an application program that integrates AI and AR functions, and output the application program to an AR device for application in various fields. The user can troubleshoot the fault events in the field according to the application program executed by the AR device to avoid the occurrence of errors due to human nature and lack of experience.

It will be apparent to those skilled in the art that various modifications and variations can be made to the structure of the present disclosure without departing from the scope or spirit of the present disclosure cover modifications and variations of this present disclosure provided they fall within the scope of the following claims.

What is claimed is:

1. An artificial intelligence (AI) assisted augmented reality (AR) system, comprising:
an editing platform configured to edit expert knowledge data to be a knowledge base;
a computer system coupled to the editing platform, the computer system configured to generate an AI agent module according to the knowledge base and generate a solution and an application program from analyzing query data by the AI agent module; and
an AR device coupled to the computer system, the AR device configured to obtain the application program from the computer system and execute the application program.

2. The AI assisted AR system of claim 1, further comprising:
an Internet of Things (IoT) device coupled to the computer system and configured to provide IoT data to the computer system, such that the AI agent module determines a problem corresponding to the query data according to the IoT data.

3. The AI assisted AR system of claim 2, wherein the IoT device is an Artificial Intelligence of Things (AIoT) executer.

4. The AI assisted AR system of claim 2, wherein the editing platform is further configured to edit the IoT data and the expert knowledge data to be the knowledge base.

5. The AI assisted AR system of claim 4, wherein the editing platform comprises a design builder, a gauge builder, a knowledge extractor, a knowledge editor, a Q&A experience editor, and a knowledge transformer.

6. The AI assisted AR system of claim 1, wherein the editing platform comprises a knowledge extractor, a knowledge editor, and a knowledge transformer.

7. The AI assisted AR system of claim 1, wherein the editing platform is a no-code editing platform.

8. The AI assisted AR system of claim 1, wherein the AI agent module comprises a multi-model problem identification, definition, and solution system, a knowledge application ecosystem, and a human-machine collaboration scheduling system.

9. The AI assisted AR system of claim 1, wherein the query data are provided by an electronic device, and wherein the computer system is further configured to transmit the solution to the electronic device.

10. The AI assisted AR system of claim 9, wherein the electronic device providing the query data is a computer or smart glasses.

11. The AI assisted AR system of claim 1, wherein the computer system is further configured to upload a result of executing the application program by the AR device to a management platform.

12. The AI assisted AR system of claim 1, wherein the AR device is smart glasses, a robot, or a drone.

13. The AI assisted AR system of claim 1, wherein the AR device is configured to generate a virtual screen based on execution of the application program.

14. The AI assisted AR system of claim 13, wherein the AR device comprises transparent lenses for displaying a real scene as well as the virtual screen.

15. The AI assisted AR system of claim 13, wherein the AR device comprises:
an image sensor configured to capture a real scene;
a processor configured to superimpose the real scene and the virtual screen; and
a screen configured to display a superimposed image of the real scene and the virtual screen.

16. A non-transitory computer readable medium storing computer program instructions that, when executed by a processor, cause the processor to:
edit expert knowledge data to be a knowledge base;
generate an artificial intelligence (AI) agent module according to the knowledge base;
execute the AI agent module;
generate a solution and an application program from analyzing query data by the AI agent module; and
provide the application program to an augmented reality (AR) for execution.

17. The non-transitory computer readable medium of claim 16, wherein the computer program instructions further cause the processor to:
detect an execution result of the application program and uploads a report.

18. The non-transitory computer readable medium of claim 16, wherein the computer program instructions further cause the processor to:
edit extracted data into the knowledge base according to a particular knowledge.

19. The non-transitory computer readable medium of claim 16, wherein the computer program instructions further cause the processor to:
transform data in the knowledge base into machine readable data.

20. The non-transitory computer readable medium of claim 16, wherein the computer program instructions further cause the processor to:
receive IoT data for the AI agent module to determine a problem corresponding to the query data according to the IoT data.
